(19) United States
(12) Patent Application Publication
(10) Pub. No.: US 2025/0330295 A1
(43) Pub. Date: Oct. 23, 2025

(54) BEAM MANAGEMENT METHOD AND APPARATUS

(71) Applicant: Beijing Xiaomi Mobile Software Co., Ltd., Beijing (CN)

(72) Inventor: Liangang CHI, Beijing (CN)

(73) Assignee: Beijing Xiaomi Mobile Software Co., Ltd., Beijing (CN)

(21) Appl. No.: 18/871,837

(22) PCT Filed: Jun. 9, 2022
(86) PCT No.: PCT/CN2022/097971

§ 371 Date: Dec. 5, 2024

(51) Int. Cl. H04L 5/00; H04B 7/06; H04W 24/10

(52) U.S. Cl. CPC H04L 5/0098; H04B 7/06952; H04W 24/10

(57) ABSTRACT

The present application relates to the technical field of communications, and provides a beam management method and apparatus, a device, and a storage medium. The method includes: sending, on the basis of frequency band information of a measurement reference signal, the measurement reference signal to a terminal by using a beam corresponding to the frequency band information.

### CROSS-REFERENCE TO RELATED APPLICATION

The present application is a National Stage of International Application No. PCT/CN2022/097971, filed on Jun. 9, 2022, the entire disclosure of which is incorporated herein by reference for all purposes.

### TECHNICAL FIELD

The present disclosure relates to the field of communication technology, and in particular to a beam management method, apparatus, device and storage medium.

### BACKGROUND

In a communication system, due to the rapid attenuation of high-frequency channels, in order to ensure the coverage of new wireless technology (New Radio, NR), beam-based transmission and reception are required. During the beam management process, the beam can be measured and managed. However, in the related art, beam management only performs beam measurement and reporting based on the reference signal of the current frequency band. When a narrow beam in a high frequency band is used for data transmission, it is impossible to quickly determine the range of the beam and realize real-time beam tracking.

### SUMMARY

The present disclosure proposes a beam management method, apparatus, device and storage medium.

An embodiment of one aspect of the present disclosure provides a beam management method, performed by a network side device, and the method including:
sending a measurement reference signal to a terminal device by using a beam corresponding to frequency band information, based on the frequency band information of the measurement reference signal.

An embodiment of another aspect of the present disclosure provides a beam management method, performed by a terminal device, and the method including:
receiving a measurement reference signal sent by a network side device using a beam corresponding to frequency band information of the measurement reference signal.

An embodiment of yet another aspect of the present disclosure provides a beam management apparatus, arranged at a network side, and the apparatus including:
a sending module, configured to send a measurement reference signal to a terminal device by using a beam corresponding to frequency band information, based on the frequency band information of the measurement reference signal.

An embodiment of yet another aspect of the present disclosure provides a beam management apparatus, arranged at a terminal side, and the apparatus including:
a receiving module, configured to receive a measurement reference signal sent by a network side device using a beam corresponding to frequency band information of the measurement reference signal.

An embodiment of yet another aspect of the present disclosure provides a terminal device, including a processor and a memory, wherein the memory stores a computer program, and the processor executes the computer program stored in the memory, so that the device performs the method proposed in the above embodiment of one aspect.

An embodiment of yet another aspect of the present disclosure provides a network side device, including a processor and a memory, wherein the memory stores a computer program, and the processor executes the computer program stored in the memory, so that the device performs the method proposed in the above embodiment of another aspect.

An embodiment of yet another aspect of the present disclosure provides a communication apparatus, including: a processor and an interface circuit, wherein
the interface circuit is configured to receive code instructions and transmit them to the processor; the processor is configured to execute the code instructions to perform the method according to the above embodiment of one aspect.

An embodiment of yet another aspect of the present disclosure provides a communication apparatus, including: a processor and an interface circuit, wherein
the interface circuit is configured to receive code instructions and transmit them to the processor; the processor is configured to execute the code instructions to perform the method according to the above embodiment of another aspect.

An embodiment of yet another aspect of the present disclosure provides a non- transitory computer-readable storage medium, having instructions stored thereon, wherein the method according to the above embodiment of one aspect is implemented when the instructions are executed.

An embodiment of yet another aspect of the present disclosure provides a non- transitory computer-readable storage medium, having instructions stored thereon, wherein the method according to the above embodiment of another aspect is implemented when the instructions are executed.

### BRIEF DESCRIPTION OF THE DRAWINGS

The above and/or additional aspects and advantages of the present disclosure will become apparent and easy to understand from the following description of the embodiments in conjunction with the accompanying drawings, wherein:

FIG. 1 is a flowchart of a beam management method provided by an embodiment of the present disclosure;

FIG. 2 is a flowchart of a beam management method provided by another embodiment of the present disclosure;

FIG. 3 is a flowchart of a beam management method provided by another embodiment of the present disclosure;

FIG. 4 is a flowchart of a beam management method provided by another embodiment of the present disclosure;

FIG. 5 is a flowchart of a beam management method provided by another embodiment of the present disclosure;

FIG. 6 is a flowchart of a beam management method provided by another embodiment of the present disclosure;

FIG. 7 is a flowchart of a beam management method provided by another embodiment of the present disclosure;

FIG. 8 is a flowchart of a beam management method provided by another embodiment of the present disclosure;

FIG. 9 is a flowchart of a beam management method provided by another embodiment of the present disclosure;

FIG. 10 is a flowchart of a beam management method provided by another embodiment of the present disclosure;

FIG. 11 is a schematic diagram of the structure of a beam management apparatus provided by an embodiment of the present disclosure;

FIG. 12 is a schematic diagram of the structure of a beam management apparatus provided by another embodiment of the present disclosure;

FIG. 13 is a schematic diagram of the structure of a beam management apparatus provided by another embodiment of the present disclosure;

FIG. 14 is a schematic diagram of the structure of a beam management apparatus provided by another embodiment of the present disclosure;

FIG. 15 is a block diagram of a terminal device provided by an embodiment of the present disclosure; and

FIG. 16 is a block diagram of a network side device provided by an embodiment of the present disclosure.

### DETAILED DESCRIPTION

Here, example embodiments will be described in detail, examples of which are shown in the accompanying drawings. When the following description refers to the drawings, unless otherwise indicated, the same numbers in different drawings represent the same or similar elements. The implementations described in the following example embodiments do not represent all implementations consistent with the embodiments of the present disclosure. Instead, they are only examples of apparatuses and methods consistent with some aspects of the embodiments of the present disclosure as detailed in the attached claims.

The terms used in the embodiments of the present disclosure are only for the purpose of describing specific embodiments and are not intended to limit the embodiments of the present disclosure. The singular forms “one” and “the” used in the embodiments of the present disclosure and the attached claims are also intended to include the plural forms, unless the context clearly indicates other meanings. It should also be understood that, the term “and/or” used herein refers to and includes any or all possible combinations of one or more associated listed items.

It should be understood that although the terms first, second, third, etc. may be used in the embodiments of the present disclosure to describe various information, the information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the words “if” and “in case” as used herein may be interpreted as “at the time of . . . ” or “when . . . ” or “in response to determining”.

The network elements or network functions involved in the embodiments of the present disclosure may be implemented by independent hardware devices or by software in hardware devices, and this is not limited in the embodiments of the present disclosure.

With rapid development of communication technology, millimeter wave communication has become a key technology of the New Radio (NR) of the 5th Generation Mobile Communication Technology (5G). As low-frequency wireless spectrum resources are exhausted, the development and utilization of high-frequency millimeter waves and even terahertz communication technology has become an inevitable trend.

In an embodiment of the present disclosure, in terms of terahertz wireless communication spectrum allocation, the International Telecommunication Union (ITU) has completed the frequency division of various frequency-using services in the frequency range of 100˜275 GHz. Among them, the globally unified spectrum allocated for land mobile services and fixed services is 97.2 GHz. At the 2019 World Radio Conference (WRC-19), four globally identified mobile service frequency bands of 275˜296GHz, 306˜313 GHz, 318-333 GHz, and 356˜450 GHz were added to the frequency range of 275˜450 GHz for land mobile services and fixed services, with a total of 137 GHz of newly added spectrum bandwidth.

With the development of communication technology, a terahertz communication task group can be established to promote the work of wireless technology. Terahertz communication is an important candidate technology for the sixth generation of mobile communication technology (6th generation wireless systems, 6G) communication. The key technologies, application vision and standardization of terahertz communication are studied and discussed. This has laid a foundation for research and industry consensus for terahertz communication to enter International Mobile Telecommunications (IMT) technical standards.

The following is a detailed description of a beam management method, apparatus, device and storage medium provided in the embodiment of the present disclosure with reference to the accompanying drawings.

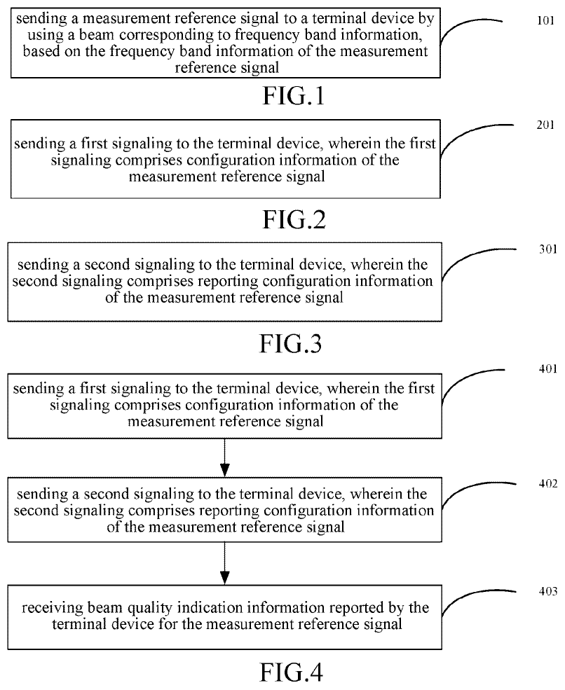

FIG. 1 is a flowchart of a beam management method provided in the embodiment of the present disclosure. The method is executed by a network side device. As shown in FIG. 1, the method may include the following step:
step 101, sending a measurement reference signal to a terminal device by using a beam corresponding to frequency band information, based on the frequency band information of the measurement reference signal.

It should be noted that, in one embodiment of the present disclosure, the terminal device may be a device that provides voice and/or data connectivity to the user. The terminal device can communicate with one or more core networks via RAN (Radio Access Network). The terminal device can be an IoT terminal, such as a sensor device, a mobile phone (or “cellular” phone), and a computer with an IoT terminal. For example, it can be a fixed, portable, pocket-sized, handheld, computer built-in, or vehicle-mounted device. For example, a station (STA), a subscriber unit, a subscriber station, a mobile station, a mobile, a remote station, an access point, a remote terminal, an access terminal, a user terminal, or a user agent. Alternatively, the terminal device can also be a device of an unmanned aerial vehicle. Alternatively, the terminal device can also be a vehicle-mounted device, such as a driving computer with wireless communication function, or a wireless terminal externally connected to a driving computer. Alternatively, the terminal device can also be a roadside device, such as a street lamp, a signal lamp, or other roadside device with wireless communication function.

In one embodiment of the present disclosure, the embodiment of the present disclosure can be applied to millimeter wave communication or terahertz communication scenarios.

And, in one embodiment of the present disclosure, sending a measurement reference signal to a terminal device by using a beam corresponding to frequency band information, based on the frequency band information of the measurement reference signal includes at least one of the following:
if the frequency band information of the measurement reference signal is low frequency band information, sending the measurement reference signal to the terminal device by using a wide beam preferentially;
if the frequency band information of the measurement reference signal is high frequency band information, sending the measurement reference signal to the terminal device by using a narrow beam preferentially.

And, in one embodiment of the present disclosure, the method further includes:
sending a first signaling to the terminal device, wherein the first signaling includes configuration information of the measurement reference signal.

And, in one embodiment of the present disclosure, the configuration information includes at least one of the following:
configuration information of a frequency band occupied by the measurement reference signal;
configuration information of a resource block or subcarrier occupied by the measurement reference signal;
configuration information of an antenna port occupied by the measurement reference signal; configuration information of a time-frequency resource position occupied by the measurement reference signal;
configuration information of a generation parameter of a measurement reference signal sequence.

And, in one embodiment of the present disclosure, the method further includes:
sending a second signaling to the terminal device, wherein the second signaling includes reporting configuration information of the measurement reference signal.

And, in one embodiment of the present disclosure, the reporting configuration information includes at least one of the following:
measurement information of the beam;
reporting condition information of beam measurement;
reporting period information of the beam measurement.

And, in one embodiment of the present disclosure, the method further includes: receiving beam quality indication information reported by the terminal device for the measurement reference signal.

And, in one embodiment of the present disclosure, the beam quality indication information includes at least one of the following:
indication information of the measurement reference signal corresponding to the beam; measurement information of beam quality.

For example, in one embodiment of the present disclosure, indication information of the measurement reference signal corresponding to the beam includes at least one of the following:
indication information of a frequency band occupied by the measurement reference signal;
indication information of a resource block or subcarrier occupied by the measurement reference signal;
indication information of an antenna port occupied by the measurement reference signal; indication information of time-frequency resource occupied by the measurement reference signal.

For example, in one embodiment of the present disclosure, the measurement information of beam quality includes at least one of reference signal received power (RSRP), reference signal received quality (RSRQ), and signal to interference and noise ratio (SINR).

For example, in one embodiment of the present disclosure, the method further includes:
sending a third signaling to the terminal device, wherein the third signaling includes beam indication information, and the beam indication information is used to indicate a used beam of a data channel and a demodulation reference signal.

For example, in one embodiment of the present disclosure, the beam indication information includes at least one of the following:
beam indication information for an index of the used beam;
beam indication information for the measurement reference signal associated with the used beam.

In summary, in the embodiment of the present disclosure, based on the frequency band information of the measurement reference signal, a beam corresponding to the frequency band information is used to send the measurement reference signal to the terminal device. In the embodiment of the present disclosure, since the beam corresponds to the frequency band information, the effectiveness of transmission of the measurement reference signal can be improved, the condition of poor beam management accuracy due to mismatch between the measurement reference signal and the beam management range can be relieved, and the accuracy of the beam quality measurement can be improved. The present disclosure provides a processing method for a “beam management” situation, to provide the frequency band information of the measurement reference signal, use a measurement reference signal transmission scheme combining high and low frequency bands, improve the effectiveness of transmission of the measurement reference signal, and thereby improve the accuracy of the beam quality measurement.

For example, when the network side device sends a measurement reference signal to a terminal device by using a beam corresponding to frequency band information, based on the frequency band information of the measurement reference signal, it may include at least one of the following:
if the frequency band information of the measurement reference signal is low frequency band information, sending the measurement reference signal to the terminal device by using a wide beam preferentially;
if the frequency band information of the measurement reference signal is high frequency band information, sending the measurement reference signal to the terminal device by using a narrow beam preferentially.

In one embodiment of the present disclosure, the network side device may configure the frequency band information of the measurement reference signal. If the frequency band information of the measurement reference signal is low frequency band information, the network side device may preferentially use a wide beam to send the measurement reference signal to the terminal device. The measurement reference signal sent using the wide beam is used for coarse beam tracking. Different beams correspond to different measurement periods.

For example, in one embodiment of the present disclosure, for example, when the frequency band information of the measurement reference signal is 6 GHz frequency information, the network side device may preferentially use a wide beam to send the measurement reference signal to the terminal device. For example, when the network side device uses a wide beam to send a measurement reference signal to perform beam traversal on the cell coverage area, the number of beams that need to be sent is small, which can reduce the beam traversal duration of the entire cell coverage area.

In one embodiment of the present disclosure, the network side device can configure the frequency band information of the measurement reference signal. If the frequency band information of the measurement reference signal is high frequency band information, the network side device can preferentially use a narrow beam to send the measurement reference signal to the terminal device, wherein the measurement reference signal sent using a narrow beam is used for fine beam tracking.

In summary, in the embodiment of the present disclosure, based on the frequency band information of the measurement reference signal, a beam corresponding to the frequency band information is used to send the measurement reference signal to the terminal device. In the embodiment of the present disclosure, it is specifically described that when the frequency band information of the measurement reference signal is low frequency band information, a wide beam is preferentially used to send the measurement reference signal to the terminal device, and when the frequency band information of the measurement reference signal is high frequency band information, a narrow beam is preferentially used to send the measurement reference signal to the terminal device. Since the beam corresponds to the frequency band information, the beam measurement quality and beam measurement efficiency can be balanced, the effectiveness of transmission of the measurement reference signal can be improved, the condition of poor beam management accuracy due to mismatch between the measurement reference signal and the beam management range can be relieved, and the accuracy of the beam quality measurement can be improved. The present disclosure provides a processing method for a “beam management” situation, to provide the frequency band information of the measurement reference signal, use a measurement reference signal transmission scheme combining high and low frequency bands, improve the effectiveness of transmission of the measurement reference signal, and thereby improve the accuracy of the beam quality measurement.

FIG. 2 is a flow diagram of a beam management method provided by an embodiment of the present disclosure, and the method is executed by a network side device. As shown in FIG. 2, the method may include the following step:
step 201, sending a first signaling to the terminal device, wherein the first signaling includes configuration information of the measurement reference signal.

In one embodiment of the present disclosure, the first signaling refers to the signaling used to send the configuration information of the measurement reference signal, and “first” in the first signaling is only used to distinguish it from the other signalings, and the first signaling does not specifically refer to a fixed signaling. For example, when the configuration information of the measurement reference signal changes, the first signaling can also change accordingly. For example, when the sending time point of the first signaling changes, the first signaling can also change accordingly.

In one embodiment of the present disclosure, the configuration information includes at least one of the following:
configuration information of a frequency band occupied by the measurement reference signal;
configuration information of a resource block or subcarrier occupied by the measurement reference signal;
configuration information of an antenna port occupied by the measurement reference signal; configuration information of a time-frequency resource position occupied by the measurement reference signal;
configuration information of a generation parameter of a measurement reference signal sequence.

In summary, in an embodiment of the present disclosure, a first signaling is sent to a terminal device, wherein the first signaling includes the configuration information of the measurement reference signal. In the embodiment of the present disclosure, by sending the configuration information of the measurement reference signal to the terminal device, the accuracy of reception of the measurement reference signal of the terminal device can be improved, the condition of poor beam management accuracy due to mismatch between the measurement reference signal and the beam management range can be relieved, and the accuracy of the beam quality measurement can be improved. The present disclosure provides a processing method for a “beam management” situation, to provide the configuration information of the measurement reference signal, use a measurement reference signal transmission scheme combining high and low frequency bands, improve the effectiveness of transmission of the measurement reference signal, and thereby improve the accuracy of the beam quality measurement.

FIG. 3 is a flowchart of a beam management method provided by an embodiment of the present disclosure, the method is executed by a network side device, as shown in FIG. 3, the method may include the following step:
step S301, sending a second signaling to the terminal device, wherein the second signaling includes reporting configuration information of the measurement reference signal.

In one embodiment of the present disclosure, the second signaling refers to the signaling used to send the reporting configuration information of the measurement reference signal, and “second” in the second signaling is only used to distinguish from the other signalings, and the second signaling does not specifically refer to a fixed signaling. For example, when the reporting configuration information of the measurement reference signal changes, the second signaling may also change accordingly. For example, when the sending time point of the second signaling changes, the second signaling may also change accordingly.

In one embodiment of the present disclosure, the reporting configuration information includes at least one of the following:
measurement information of the beam;
reporting condition information of beam measurement;
reporting period information of the beam measurement.

And, in one embodiment of the present disclosure, the reporting configuration information is not fixed information. For example, when the information included in the reporting configuration information changes, the reporting configuration information may also change accordingly. For example, when the amount of information included in the reporting configuration information changes, the reporting configuration information may also change accordingly.

And, in one embodiment of the present disclosure, the measurement information is used to indicate the measurement quantity of the beam, that is, the specific measurement information when measuring the beam. The measurement information does not specifically refer to fixed measurement information. For example, when at least one measurement quantity corresponding to the measurement information changes, the measurement information may also change accordingly.

And, in one embodiment of the present disclosure, the reporting condition information of the beam measurement is used to indicate the conditions for the terminal device to report the beam quality indication information.

In summary, in the embodiment of the present disclosure, a second signaling is sent to the terminal device, wherein the second signaling includes reporting configuration information of the measurement reference signal. In the embodiment of the present disclosure, by sending the reporting configuration information of the measurement reference signal to the terminal device, the condition of poor beam management accuracy due to mismatch between the measurement reference signal and the beam management range can be relieved, and the accuracy of the beam measurement quality can be improved. The present disclosure provides a processing method for a “beam management” situation, to provide the configuration information of the measurement reference signal, use a measurement reference signal transmission scheme combining high and low frequency bands, improve the effectiveness of transmission of the measurement reference signal, and thereby improve the accuracy of the beam quality measurement.

FIG. 4 is a flowchart of a beam management method provided by an embodiment of the present disclosure. The method is executed by a network side device. As shown in FIG. 4, the method may include the following steps:
step S401, sending a first signaling to the terminal device, wherein the first signaling includes configuration information of the measurement reference signal;
step S402, sending a second signaling to the terminal device, wherein the second signaling includes reporting configuration information of the measurement reference signal;
step S403, receiving beam quality indication information reported by the terminal device for the measurement reference signal.

In one embodiment of the present disclosure, the beam quality indication information includes at least one of the following:
indication information of the measurement reference signal corresponding to the beam; measurement information of beam quality.

And, in one embodiment of the present disclosure, the execution order of step 401 and step 402 is not limited, that is, the network side device may first execute step 401 to send the first signaling to the terminal device and then execute step 402 to send the second signaling to the terminal device, or may first execute step 402 to send the second signaling to the terminal device and then execute step 401 to send the first signaling to the terminal device.

And, in one embodiment of the present disclosure, the first signaling and the second signaling may be the same signaling, that is, the signaling may simultaneously include the configuration information of the measurement reference signal and the reporting configuration information of the measurement reference signal. When the network side device sends the signaling to the terminal device, the network side device may simultaneously send the configuration information of the measurement reference signal and the reporting configuration information of the measurement reference signal to the terminal device.

And, in one embodiment of the present disclosure, the beam quality indication information is not fixed information. For example, when the information included in the beam quality indication information changes, the beam quality indication information may also change accordingly. For example, when the amount of information included in the beam quality indication information changes, the beam quality indication information may also change accordingly.

And, in one embodiment of the present disclosure, indication information of the measurement reference signal corresponding to the beam includes at least one of the following:
indication information of a frequency band occupied by the measurement reference signal;
indication information of a resource block or subcarrier occupied by the measurement reference signal;
indication information of an antenna port occupied by the measurement reference signal; indication information of time-frequency resource occupied by the measurement reference signal.

And, in one embodiment of the present disclosure, the measurement information of beam quality includes at least one of reference signal received power (RSRP), reference signal received quality (RSRQ), and signal to interference and noise ratio (SINR).

For example, in one embodiment of the present disclosure, the measurement information of the beam quality may include RSRP and RSRQ, and the measurement information of the beam quality may also include RSRP, RSRQ and SINR.

In summary, in an embodiment of the present disclosure, a first signaling is sent to a terminal device, wherein the first signaling includes configuration information of a measurement reference signal, a second signaling is sent to a terminal device, wherein the second signaling includes reporting configuration information of the measurement reference signal, and beam quality indication information reported by the terminal device for the measurement reference signal is received. In an embodiment of the present disclosure, by sending the configuration information and the reporting configuration information of the measurement reference signal to the terminal device, the accuracy of reception of the measurement reference signal of the terminal device can be improved, the condition of poor beam management accuracy due to mismatch between the measurement reference signal and the beam management range can be relieved, and the accuracy of reception of the beam quality indication information can be improved. The present disclosure provides a processing method for a “beam management” situation, to provide the configuration information of the measurement reference signal, use a measurement reference signal transmission scheme combining high and low frequency bands, improve the effectiveness of transmission of the measurement reference signal, and thereby improve the accuracy of the beam quality measurement.

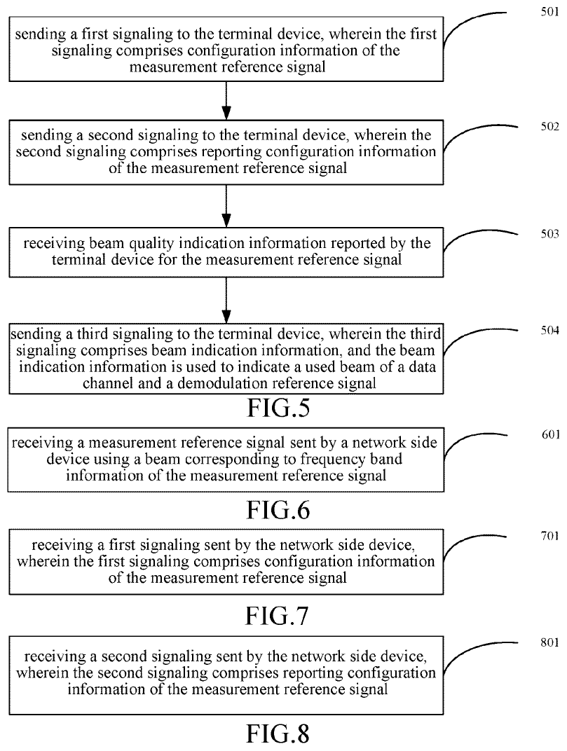

FIG. 5 is a flowchart of a beam management method provided by an embodiment of the present disclosure, which is executed by a network side device. As shown in FIG. 5, the method may include the following steps:
step S501, sending a first signaling to the terminal device, wherein the first signaling includes configuration information of the measurement reference signal;
step S502, sending a second signaling to the terminal device, wherein the second signaling includes reporting configuration information of the measurement reference signal;
step S503, receiving beam quality indication information reported by the terminal device for the measurement reference signal;
step S504, sending a third signaling to the terminal device, wherein the third signaling includes beam indication information, and the beam indication information is used to indicate a used beam of a data channel and a demodulation reference signal.

And, in one embodiment of the present disclosure, the beam indication information includes at least one of the following:
beam indication information for an index of the used beam;
beam indication information for the measurement reference signal associated with the used beam.

And, in one embodiment of the present disclosure, the beam indication information is not fixed information. For example, when the information included in the beam indication information changes, the beam indication information may also change accordingly. For example, when the amount of information included in the beam indication information changes, the beam indication information may also change accordingly. For example, the beam indication information for the index of the used beam is different from the beam indication information for the measurement reference signal associated with the used beam.

And, in one embodiment of the present disclosure, since the beam indication information is used to indicate the used beam of the data channel and the demodulation reference signal, the network side device may send a third signaling to the terminal device after receiving the beam quality indication information reported by the terminal device for the measurement reference signal.

In summary, in the embodiment of the present disclosure, a first signaling is sent to a terminal device, wherein the first signaling includes configuration information of a measurement reference signal, a second signaling is sent to the terminal device, wherein the second signaling includes reporting configuration information of the measurement reference signal, and beam quality indication information reported by the terminal device for the measurement reference signal is received. In the embodiment of the present disclosure, by sending the configuration information and the reporting configuration information of the measurement reference signal to the terminal device, the accuracy of reception of the measurement reference signal of the terminal device can be improved, the condition of poor beam management accuracy due to mismatch between the measurement reference signal and the beam management range can be relieved, and the accuracy of reception of the beam quality indication information can be improved. In the embodiment of the present disclosure, it is specifically described that sending beam indication information to the terminal device can improve the accuracy of determining the beams used for the data channel and the modulation reference signal. The present disclosure provides a processing method for a “beam management” situation, to provide the configuration information of the measurement reference signal, use a measurement reference signal transmission scheme combining high and low frequency bands, improve the effectiveness of transmission of the measurement reference signal, and thereby improve the accuracy of the beam quality measurement.

FIG. 6 is a flowchart of a beam management method provided by an embodiment of the present disclosure. The method is executed by a terminal device. As shown in FIG. 6, the method may include the following steps:
step 601, receiving a measurement reference signal sent by a network side device using a beam corresponding to frequency band information of the measurement reference signal.

In one embodiment of the present disclosure, receiving a measurement reference signal sent by a network side device using a beam corresponding to frequency band information of the measurement reference signal includes at least one of the following:
if the frequency band information of the measurement reference signal is low frequency band information, receiving the measurement reference signal sent by the network side device using a wide beam preferentially;
if the frequency band information of the measurement reference signal is high frequency band information, receiving the measurement reference signal sent by the network side device using a narrow beam preferentially.

For example, in an embodiment of the present disclosure, the method further includes:
receiving a first signaling sent by the network side device, wherein the first signaling includes configuration information of the measurement reference signal.

For example, in an embodiment of the present disclosure, the configuration information includes at least one of the following:
configuration information of a frequency band occupied by the measurement reference signal;
configuration information of a resource block or subcarrier occupied by the measurement reference signal;
configuration information of an antenna port occupied by the measurement reference signal; configuration information of a time-frequency resource position occupied by the measurement reference signal;
configuration information of a generation parameter of a measurement reference signal sequence.

For example, in an embodiment of the present disclosure, the method further includes:
receiving a second signaling sent by the network side device, wherein the second signaling includes reporting configuration information of the measurement reference signal.

For example, in an embodiment of the present disclosure, the reporting configuration information includes at least one of the following:
measurement information of the beam;
reporting condition information of beam measurement;
reporting period information of the beam measurement.

For example, in an embodiment of the present disclosure, the method further includes:
receiving the measurement reference signal based on configuration information of the measurement reference signal sent by the network side device;
acquiring beam quality indication information by performing beam measurement on the measurement reference signal, based on reporting configuration information of the measurement reference signal sent by the network side device;
sending the beam quality indication information to the network side device.

For example, in an embodiment of the present disclosure, the beam quality indication information includes at least one of the following:
indication information of the measurement reference signal corresponding to the beam; measurement information of beam quality.

For example, in an embodiment of the present disclosure, indication information of the measurement reference signal corresponding to the beam includes at least one of the following:
indication information of a frequency band occupied by the measurement reference signal;
indication information of a resource block or subcarrier occupied by the measurement reference signal;
indication information of an antenna port occupied by the measurement reference signal;
indication information of time-frequency resource occupied by the measurement reference signal.

For example, in an embodiment of the present disclosure, the measurement information of beam quality includes at least one of RSRP, RSRQ, and SINR.

For example, in an embodiment of the present disclosure, the method further includes:
receiving a third signaling sent by the network side device, wherein the third signaling includes beam indication information, and the beam indication information is used to indicate a used beam of a data channel and a demodulation reference signal;
receiving or sending the demodulation reference signal by using the used beam, based on the beam indication information.

For example, in an embodiment of the present disclosure, the beam indication information includes at least one of the following:
beam indication information for an index of the used beam;
beam indication information for the measurement reference signal associated with the used beam.

In summary, in the embodiment of the present disclosure, a measurement reference signal sent by a network side device using a beam corresponding to frequency band information of the measurement reference signal is received. In the embodiment of the present disclosure, since the beam corresponds to the frequency band information, the effectiveness of transmission of the measurement reference signal can be improved, the condition of poor beam management accuracy due to mismatch between the measurement reference signal and the beam management range can be relieved, and the accuracy of the beam quality measurement can be improved. The present disclosure provides a processing method for a “beam management” situation, to provide the frequency band information of the measurement reference signal, use a measurement reference signal transmission scheme combining high and low frequency bands, improve the effectiveness of transmission of the measurement reference signal, and thereby improve the accuracy of the beam quality measurement.

For example, when a terminal device receives a measurement reference signal sent by a network side device using a beam corresponding to frequency band information of the measurement reference signal, at least at least one of the following is performed:
if the frequency band information of the measurement reference signal is low frequency band information, receiving the measurement reference signal sent by the network side device using a wide beam preferentially;
if the frequency band information of the measurement reference signal is high frequency band information, receiving the measurement reference signal sent by the network side device using a narrow beam preferentially.

In summary, in the embodiment of the present disclosure, a measurement reference signal sent by a network side device using a beam corresponding to frequency band information of the measurement reference signal is received. In the embodiment of the present disclosure, it is specifically described that if the frequency band information of the measurement reference signal is low frequency band information, the measurement reference signal sent by the network side device using a wide beam preferentially is received, if the frequency band information of the measurement reference signal is high frequency band information, the measurement reference signal sent by the network side device using a narrow beam preferentially is received. Since the beam corresponds to the frequency band information, the beam measurement quality and beam measurement efficiency can be balanced, the effectiveness of transmission of the measurement reference signal can be improved, the condition of poor beam management accuracy due to mismatch between the measurement reference signal and the beam management range can be relieved, and the accuracy of the beam quality measurement can be improved. The present disclosure provides a processing method for a “beam management” situation, to provide the frequency band information of the measurement reference signal, use a measurement reference signal transmission scheme combining high and low frequency bands, improve the effectiveness of transmission of the measurement reference signal, and thereby improve the accuracy of the beam quality measurement.

FIG. 7 is a flow diagram of a beam management method provided by an embodiment of the present disclosure, and the method is executed by a terminal device. As shown in FIG. 7, the method may include the following step:
step 701, receiving a first signaling sent by the network side device, wherein the first signaling includes configuration information of the measurement reference signal.

In one embodiment of the present disclosure, the configuration information includes at least one of the following:
configuration information of a frequency band occupied by the measurement reference signal;
configuration information of a resource block or subcarrier occupied by the measurement reference signal;
configuration information of an antenna port occupied by the measurement reference signal;
configuration information of a time-frequency resource position occupied by the measurement reference signal;
configuration information of a generation parameter of a measurement reference signal sequence.

In summary, in the embodiment of the present disclosure, the first signaling sent by the network side device is received, wherein the first signaling includes the configuration information of the measurement reference signal. In the embodiment of the present disclosure, by receiving the configuration information of the measurement reference signal sent by the network side device, the accuracy of reception of the measurement reference signal can be improved, the condition of poor beam management accuracy due to mismatch between the measurement reference signal and the beam management range can be relieved, and the accuracy of the beam quality measurement can be improved. The present disclosure provides a processing method for a “beam management” situation, to provide the configuration information of the measurement reference signal, use a measurement reference signal transmission scheme combining high and low frequency bands, improve the effectiveness of transmission of the measurement reference signal, and thereby improve the accuracy of the beam quality measurement.

FIG. 8 is a flowchart of a beam management method provided by an embodiment of the present disclosure, and the method is executed by a terminal device. As shown in FIG. 8, the method may include the following step:
step 801, receiving a second signaling sent by the network side device, wherein the second signaling includes reporting configuration information of the measurement reference signal.

For example, in an embodiment of the present disclosure, the reporting configuration information includes at least one of the following:
measurement information of the beam;
reporting condition information of beam measurement;
reporting period information of the beam measurement.

In summary, in an embodiment of the present disclosure, a second signaling sent by the network side device is received, wherein the second signaling includes reporting configuration information of the measurement reference signal. In an embodiment of the present disclosure, by receiving the reporting configuration information of the measurement reference signal, the accuracy of the measurement of the measurement reference signal of the terminal device can be improved, the condition of poor beam management accuracy due to mismatch between the measurement reference signal and the beam management range can be relieved, and the accuracy of the beam measurement quality can be improved. The present disclosure provides a processing method for a “beam management” situation, to provide the configuration information of the measurement reference signal, use a measurement reference signal transmission scheme combining high and low frequency bands, improve the effectiveness of transmission of the measurement reference signal, and thereby improve the accuracy of the beam quality measurement.

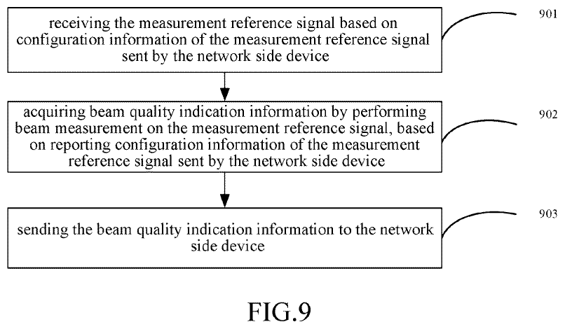

FIG. 9 is a flowchart of a beam management method provided by an embodiment of the present disclosure, which is executed by a terminal device. As shown in FIG. 9, the method may include the following steps:
step 901, receiving the measurement reference signal based on configuration information of the measurement reference signal sent by the network side device;
step 902, acquiring beam quality indication information by performing beam measurement on the measurement reference signal, based on reporting configuration information of the measurement reference signal sent by the network side device;
step 903, sending the beam quality indication information to the network side device.

In one embodiment of the present disclosure, the beam quality indication information includes at least one of the following:
indication information of the measurement reference signal corresponding to the beam; measurement information of beam quality.

For example, in one embodiment of the present disclosure, indication information of the measurement reference signal corresponding to the beam includes at least one of the following:
indication information of a frequency band occupied by the measurement reference signal;
indication information of a resource block or subcarrier occupied by the measurement reference signal;
indication information of an antenna port occupied by the measurement reference signal;
indication information of time-frequency resource occupied by the measurement reference signal.

In one embodiment of the present disclosure, the measurement information of beam quality includes at least one of RSRP, RSRQ, and SINR.

For example, in one embodiment of the present disclosure, the terminal device can receive the first signaling sent by the network side device. Since the first signaling includes the configuration information of the measurement reference signal, the terminal device can obtain the configuration information of the measurement reference signal. The terminal device can receive the second signaling sent by the network side device. Since the second signaling includes the reporting configuration information of the measurement reference signal, the terminal device can obtain the reporting configuration information of the measurement reference signal. Therefore, the terminal device can receive the measurement reference signal based on the configuration information of the measurement reference signal sent by the network side device, and perform beam measurement on the measurement reference signal based on the reporting configuration information of the measurement reference signal sent by the network side device, and obtain beam quality indication information.

For example, in one embodiment of the present disclosure, the execution order of the terminal device receiving the first signaling and the terminal device receiving the second signaling is not limited. For example, when the network side device sends the second signaling first and then sends the first signaling, the terminal device can first execute the terminal device receiving the second signaling and then execute the terminal device receiving the first signaling. For example, when the network side device sends the first signaling first and then sends the second signaling, the terminal device can first execute the terminal device receiving the first signaling and then execute the terminal device receiving the second signaling. For example, when the network side device uses the same signaling to send the configuration information of the measurement reference signal and the reporting configuration information of the measurement reference signal, that is, the first signaling and the second signaling are the same signaling, the terminal device can receive the signaling, and the terminal device can simultaneously receive the configuration information of the measurement reference signal and the reporting configuration information of the measurement reference signal.

In summary, in the embodiments of the present disclosure, based on the configuration information of the measurement reference signal sent by the network side device, the measurement reference signal is received, based on the reporting configuration information of the measurement reference signal sent by the network side device, beam measurement is performed on the measurement reference signal, and beam quality indication information is obtained, and the beam quality indication information can be sent to the network side device. In the embodiments of the present disclosure, the beam quality indication information is obtained based on the configuration information and reporting configuration information of the measurement reference signal sent by the network side device, which can improve the accuracy of reception of the measurement reference signal of the terminal device, relieve the poor beam management accuracy due to mismatch between the measurement reference signal and the beam management range, and improve the accuracy of reception of the beam quality indication information. The present disclosure provides a processing method for a “beam management” situation, to provide the configuration information of the measurement reference signal, use a measurement reference signal transmission scheme combining high and low frequency bands, improve the effectiveness of transmission of the measurement reference signal, and thereby improve the accuracy of the beam quality measurement.

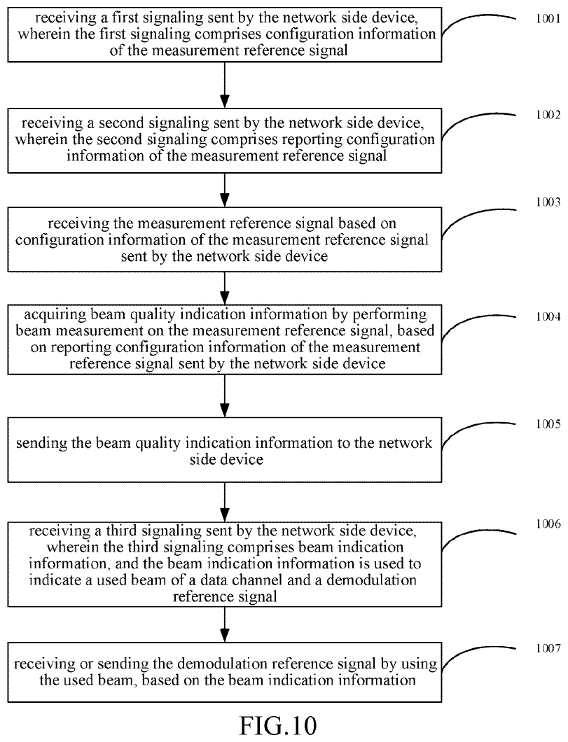

FIG. 10 is a flowchart of a beam management method provided by an embodiment of the present disclosure. The method is executed by a terminal device. As shown in FIG. 10, the method may include the following steps:
step 1001, receiving a first signaling sent by the network side device, wherein the first signaling includes configuration information of the measurement reference signal;
step 1002, receiving a second signaling sent by the network side device, wherein the second signaling includes reporting configuration information of the measurement reference signal;
step 1003, receiving the measurement reference signal based on configuration information of the measurement reference signal sent by the network side device;
step 1004, acquiring beam quality indication information by performing beam measurement on the measurement reference signal, based on reporting configuration information of the measurement reference signal sent by the network side device;
step 1005, sending the beam quality indication information to the network side device.
step 1006, receiving a third signaling sent by the network side device, wherein the third signaling includes beam indication information, and the beam indication information is used to indicate a used beam of a data channel and a demodulation reference signal;
step 1007, receiving or sending the demodulation reference signal by using the used beam, based on the beam indication information.

In one embodiment of the present disclosure, the beam indication information includes at least one of the following:
beam indication information for an index of the used beam;
beam indication information for the measurement reference signal associated with the used beam.

In summary, in the embodiment of the present disclosure, a first signaling sent by a network side device is received, wherein the first signaling includes configuration information of a measurement reference signal, a second signaling sent by the network side device is received, wherein the second signaling includes reporting configuration information of the measurement reference signal, based on the configuration information of the measurement reference signal sent by the network side device, a measurement reference signal is received, based on the reporting configuration information of the measurement reference signal sent by the network side device, beam measurement is performed on the measurement reference signal, beam quality indication information is obtained, and the beam quality indication information is sent to the network side device, and a third signaling sent by the network side device is received, wherein the third signaling includes beam indication information, and the beam indication information is used to indicate the used beam of the data channel and the demodulation reference signal, and based on the beam indication information, the demodulation reference signal is received or sent using the used beam. In the embodiment of the present disclosure, by receiving the configuration information and reporting configuration information of the measurement reference signal sent by the network side device, the accuracy of reception of the measurement reference signal of the terminal device can be improved, the condition of poor beam management accuracy due to mismatch between the measurement reference signal and the beam management range can be relieved, and the accuracy of reception of the beam quality indication information can be improved. In the embodiment of the present disclosure, it is specifically described that sending beam indication information to the terminal device can improve the accuracy of determining the beams used for the data channel and the modulation reference signal. The present disclosure provides a processing method for a “beam management” situation, to provide the configuration information of the measurement reference signal, use a measurement reference signal transmission scheme combining high and low frequency bands, improve the effectiveness of transmission of the measurement reference signal, and thereby improve the accuracy of the beam quality measurement.

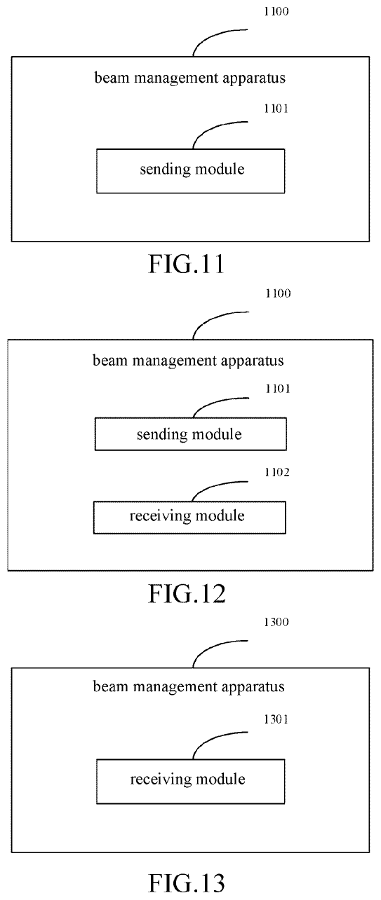

FIG. 11 is a structural schematic diagram of a beam management apparatus provided by an embodiment of the present disclosure. As shown in FIG. 11, the apparatus 1100 can be provided at the network side, and the apparatus 1100 can include:
a sending module 1101, configured to send a measurement reference signal to a terminal device by using a beam corresponding to frequency band information, based on the frequency band information of the measurement reference signal.

In summary, in the beam management apparatus of the embodiment of the present disclosure, the sending module can use the beam corresponding to the frequency band information to send the measurement reference signal to the terminal device based on the frequency band information of the measurement reference signal. In the embodiment of the present disclosure, since the beam corresponds to the frequency band information, the effectiveness of transmission of the measurement reference signal can be improved, the condition of poor beam management accuracy due to mismatch between the measurement reference signal and the beam management range can be relieved, and the accuracy of beam quality measurement can be improved. The present disclosure provides a processing apparatus for a “beam management” situation, to provide the frequency band information of the measurement reference signal, use a measurement reference signal transmission scheme combining high and low frequency bands, improve the effectiveness of transmission of the measurement reference signal, and thereby improve the accuracy of the beam quality measurement.

Optionally, in one embodiment of the present disclosure, the sending module 1101 is used to send a measurement reference signal to a terminal device by using a beam corresponding to frequency band information, based on the frequency band information of the measurement reference signal, including at least one of the following:
if the frequency band information of the measurement reference signal is low frequency band information, sending the measurement reference signal to the terminal device by using a wide beam preferentially;
if the frequency band information of the measurement reference signal is high frequency band information, sending the measurement reference signal to the terminal device by using a narrow beam preferentially.

Optionally, in one embodiment of the present disclosure, the sending module 1101 is also used to:
send a first signaling to the terminal device, wherein the first signaling includes configuration information of the measurement reference signal.

Optionally, in one embodiment of the present disclosure, the configuration information includes at least one of the following:
configuration information of a frequency band occupied by the measurement reference signal;
configuration information of a resource block or subcarrier occupied by the measurement reference signal;
configuration information of an antenna port occupied by the measurement reference signal;
configuration information of a time-frequency resource position occupied by the measurement reference signal;
configuration information of a generation parameter of a measurement reference signal sequence.

Optionally, in one embodiment of the present disclosure, the sending module 1101 is further used to:
send a second signaling to the terminal device, wherein the second signaling includes reporting configuration information of the measurement reference signal.

Optionally, in one embodiment of the present disclosure, wherein the reporting configuration information includes at least one of the following:
measurement information of the beam;
reporting condition information of beam measurement;
reporting period information of the beam measurement.

Optionally, in one embodiment of the present disclosure, FIG. 12 is a structural schematic diagram of a beam management apparatus provided by an embodiment of the present disclosure. As shown in FIG. 12, the apparatus 1100 can be provided at the network side. The apparatus 1100 also includes a receiving module 1102, which is further used to: receive beam quality indication information reported by the terminal device for the measurement reference signal.

Optionally, in one embodiment of the present disclosure, the beam quality indication information includes at least one of the following:
indication information of the measurement reference signal corresponding to the beam; measurement information of beam quality.

Optionally, in one embodiment of the present disclosure, indication information of the measurement reference signal corresponding to the beam includes at least one of the following:
indication information of a frequency band occupied by the measurement reference signal;
indication information of a resource block or subcarrier occupied by the measurement reference signal;
indication information of an antenna port occupied by the measurement reference signal;
indication information of time-frequency resource occupied by the measurement reference signal.

Optionally, in one embodiment of the present disclosure, the measurement information of beam quality includes at least one of reference signal received power (RSRP), reference signal received quality (RSRQ), and signal to interference and noise ratio (SINR).

Optionally, in one embodiment of the present disclosure, the sending module 1101 is also used to:
send a third signaling to the terminal device, wherein the third signaling includes beam indication information, and the beam indication information is used to indicate a used beam of a data channel and a demodulation reference signal.

Optionally, in one embodiment of the present disclosure, the beam indication information includes at least one of the following:
beam indication information for an index of the used beam;
beam indication information for the measurement reference signal associated with the used beam.

FIG. 13 is a schematic diagram of the structure of a beam management apparatus provided by an embodiment of the present disclosure. As shown in FIG. 13, the apparatus 1300 can be provided at the terminal side, and the apparatus 1300 can include:
a receiving module 1301, used to receive a measurement reference signal sent by a network side device using a beam corresponding to frequency band information of the measurement reference signal.

In summary, in the beam management apparatus of the embodiment of the present disclosure, the receiving module can receive a measurement reference signal sent by a network side device using a beam corresponding to frequency band information of the measurement reference signal. In the embodiment of the present disclosure, since the beam corresponds to the frequency band information, the effectiveness of transmission of the measurement reference signal can be improved, and the condition of poor beam management accuracy due to mismatch between the measurement reference signal and the beam management range can be relieved, and the accuracy of beam quality measurement can be improved. The present disclosure provides a processing method for a “beam management” situation, to provide the frequency band information of the measurement reference signal, use a measurement reference signal transmission scheme combining high and low frequency bands, improve the effectiveness of transmission of the measurement reference signal, and thereby improve the accuracy of the beam quality measurement.

Optionally, in one embodiment of the present disclosure, the receiving module 1301 is used to receive a measurement reference signal sent by a network side device using a beam corresponding to frequency band information of the measurement reference signal, including at least one of the following:
if the frequency band information of the measurement reference signal is low frequency band information, receiving the measurement reference signal sent by the network side device using a wide beam preferentially;
if the frequency band information of the measurement reference signal is high frequency band information, receiving the measurement reference signal sent by the network side device using a narrow beam preferentially.

Optionally, in one embodiment of the present disclosure, the receiving module 1301 is also used to:
receive a first signaling sent by the network side device, wherein the first signaling includes configuration information of the measurement reference signal.

Optionally, in one embodiment of the present disclosure, the configuration information includes at least one of the following:
configuration information of a frequency band occupied by the measurement reference signal;
configuration information of a resource block or subcarrier occupied by the measurement reference signal;
configuration information of an antenna port occupied by the measurement reference signal;
configuration information of a time-frequency resource position occupied by the measurement reference signal;
configuration information of a generation parameter of a measurement reference signal sequence.

Optionally, in one embodiment of the present disclosure, the receiving module 1301 is also used to:
receive a second signaling sent by the network side device, wherein the second signaling includes reporting configuration information of the measurement reference signal.

Optionally, in one embodiment of the present disclosure, the reporting configuration information includes at least one of the following:
measurement information of the beam;
reporting condition information of beam measurement;
reporting period information of the beam measurement.

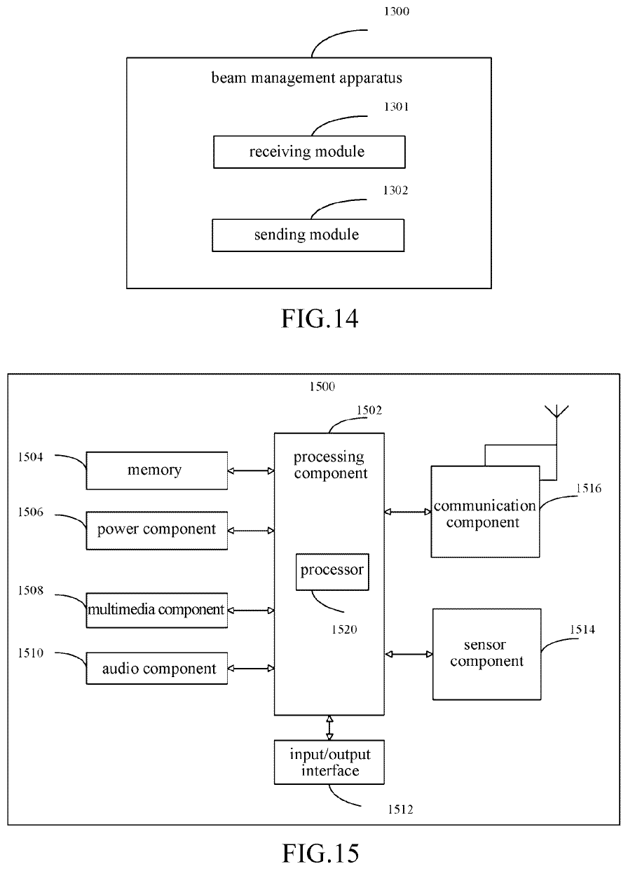

Optionally, in one embodiment of the present disclosure, FIG. 14 is a structural schematic diagram of a beam management apparatus provided by the embodiment of the present disclosure. As shown in FIG. 14, the apparatus 1300 can be provided at the terminal side. The apparatus 1300 also includes a sending module 1302, which is also used to:
receive the measurement reference signal based on configuration information of the measurement reference signal sent by the network side device;
acquire beam quality indication information by performing beam measurement on the measurement reference signal, based on reporting configuration information of the measurement reference signal sent by the network side device;
send the beam quality indication information to the network side device.

Optionally, in one embodiment of the present disclosure, the beam quality indication information includes at least one of the following:
indication information of the measurement reference signal corresponding to the beam;
measurement information of beam quality.

Optionally, in one embodiment of the present disclosure, indication information of the measurement reference signal corresponding to the beam includes at least one of the following:
indication information of a frequency band occupied by the measurement reference signal;
indication information of a resource block or subcarrier occupied by the measurement reference signal;
indication information of an antenna port occupied by the measurement reference signal;
indication information of time-frequency resource occupied by the measurement reference signal.

Optionally, in one embodiment of the present disclosure, the measurement information of beam quality includes at least one of RSRP, RSRQ, and SINR.

Optionally, in one embodiment of the present disclosure, the receiving module 1301 is also used to:
receive a third signaling sent by the network side device, wherein the third signaling includes beam indication information, and the beam indication information is used to indicate a used beam of a data channel and a demodulation reference signal;
receive or send the demodulation reference signal by using the used beam, based on the beam indication information.

Optionally, in one embodiment of the present disclosure, the beam indication information includes at least one of the following:
beam indication information for an index of the used beam;
beam indication information for the measurement reference signal associated with the used beam.

FIG. 15 is a schematic structural diagram of the terminal device UE 1500 provided by an embodiment of the present disclosure. For example, the UE 1500 may be a mobile phone, a computer, a digital broadcast device, a messaging device, a game console, a tablet device, a medical device, a fitness device, a personal digital assistant, etc.

Referring to FIG. 15, the UE 1500 may include at least one of the following components: a processing component 1502, a memory 1504, a power component 1506, a multimedia component 1508, an audio component 1510, an input/output (I/O) interface 1512, a sensor component 1514, and a communication component 1516.

The processing component 1502 typically controls the overall operations of the UE 1500, such as the operations associated with display, telephone calls, data communications, camera operations, and recording operations. The processing component 1502 can include one or more processors 1520 to execute instructions to perform all or part of the steps in the above described methods. Moreover, the processing component 1502 can include at least one module to facilitate the interaction between the processing component 1502 and other components. For example, the processing component 1502 can include a multimedia module to facilitate the interaction between the multimedia component 1508 and the processing component 1502.

The memory 1504 is configured to store various types of data to support the operation of the UE 1500. Examples of such data include instructions for any application or method operated on the, such as the contact data, the phone book data, messages, pictures, videos, and the like. The memory 1504 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1506 provides power to various components of the UE 1500. The power component 1506 can include a power management system, at least one power source, and other components associated with the generation, management, and distribution of power for the UE 1500.

The multimedia component 1508 includes a screen providing an output interface between the UE 1500 and the user. In some embodiments, the screen can include a liquid crystal display (LCD) and a touch panel (TP). If the screen includes the touch panel, the screen can be implemented as a touch screen to receive input signals from the user. The touch panel includes at least one touch sensor to sense touches, swipes, and gestures on the touch panel. The touch sensors may not only sense a boundary of a touch or swipe action, but also detect the wake-up time and pressure associated with the touch or swipe action. In some embodiments, the multimedia component 1508 includes a front camera and/or a rear camera. When the UE 1500 is in an operation mode, such as a photographing mode or a video mode, the front camera and/or the rear camera can receive external multimedia data. Each of the front camera and the rear camera may be a fixed optical lens system or have focus and optical zoom capability.

The audio component 1510 is configured to output and/or input an audio signal. For example, the audio component 1510 includes a microphone (MIC) configured to receive an external audio signal when the UE 1500 is in an operation mode, such as a call mode, a recording mode, and a voice recognition mode. The received audio signal may be further stored in the memory 1504 or sent via the communication component 1516. In some embodiments, the audio component 1510 also includes a speaker for outputting the audio signal.

The I/O interface 1512 provides an interface between the processing component 1502 and peripheral interface modules, such as keyboards, a click wheels, buttons, and the like. These buttons may include, but not limited to, a home button, a volume button, a starting button, and a locking button.

The sensor component 1514 includes at least one sensor for providing state assessments of various aspects of the UE 1500. For example, the sensor component 1514 can detect an open/closed state of the UE 1500, relative positioning of components, such as the display and the keypad of the UE 1500. The sensor component 1514 can also detect a change in position of one component of the UE 1500 or the UE 1500, the presence or absence of user contact with the UE 1500, an orientation, or an acceleration/deceleration of the UE 1500, and a change in temperature of the UE 1500. The sensor component 1514 can also include a proximity sensor configured to detect the presence of nearby objects without any physical contact. The sensor component 1514 can also include a light sensor, such as a CMOS or CCD image sensor, configured to use in imaging applications. In some embodiments, the sensor component 1514 can also include an accelerometer sensor, a gyroscope sensor, a magnetic sensor, a pressure sensor, or a temperature sensor.

The communication component 1516 is configured to facilitate wired or wireless communication between the UE 1500 and other devices. The UE 1500 can access a wireless network based on a communication standard, such as WiFi, 2G, 3G, or a combination thereof. In an example embodiment, the communication component 1516 receives broadcast signals or broadcast associated information from an external broadcast management system via a broadcast channel. In an example embodiment, the communication component 1516 also includes a near field communication (NFC) module to facilitate short-range communications. For example, the NFC module can be implemented based on radio frequency identification (RFID) technology, infrared data association (IrDA) technology, ultra-wideband (UWB) technology, Bluetooth (BT) technology and other technologies.

In an example embodiment, the UE 1500 may be implemented with at least one application specific integrated circuit (ASIC), digital signal processor (DSP), digital signal processing device (DSPD), programmable logic device (PLD), field programmable Gate array (FPGA), controller, microcontroller, microprocessor or other electronic components, to perform the above methods.

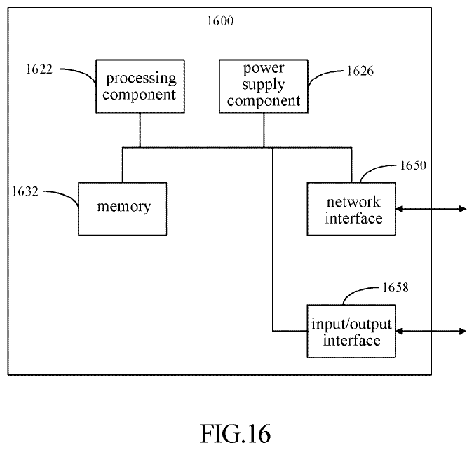

FIG. 16 is a block diagram of a network side device 1600 provided in an embodiment of the present application. For example, the network side device 1600 may be provided as a network side device 1600. Referring to FIG. 16, the network side device 1600 may include a processing component 1622, which further includes at least one processor, and memory resources represented by a memory 1632, for storing instructions, such as application programs, that can be executed by processing component 1622. An application stored in memory 1632 may include one or more modules, each of which corresponds to a set of instructions. In addition, the processing component 1622 is configured to execute instructions to execute any of the above methods applied to the network side device, for example, the method shown in FIG. 1.

The network side device 1600 may also include a power supply component 1626 configured to perform power management of the network side device 1600, a wired or wireless network interface 1650 configured to connect the network side device 1600 to the network, and an input/output (I/O) interface 1658. The network side device 1600 may operate based on an operating system stored in the memory 1632, such as Windows Server™, Mac OS X™, Unix™, Linux™, FreeBSD™ or the like.

In the above embodiments provided by the present disclosure, the methods provided by the embodiments of the present disclosure are introduced from the perspectives of the network side device and UE. In order to implement the functions of the methods provided by the above embodiments of the present disclosure, the network side device and the UE may include a hardware structure and a software module, and the above functions are implemented in the form of a hardware structure, a software module, or a hardware structure plus a software module. One of the above functions may be executed in the form of a hardware structure, a software module, or a hardware structure plus a software module.

In the above embodiments provided by the present disclosure, the methods provided by the embodiments of the present disclosure are introduced from the perspectives of the network side device and UE. In order to implement the functions of the methods provided by the above embodiments of the present disclosure, the network side device and the UE may include a hardware structure and a software module, and the above functions are implemented in the form of a hardware structure, a software module, or a hardware structure plus a software module. One of the above functions may be executed in the form of a hardware structure, a software module, or a hardware structure plus a software module.

A communication apparatus is provided in the embodiments of the present disclosure. The communication apparatus may include a transceiver module and a processing module. The transceiver module may include a sending module and/or a receiving module, the sending module is used to implement the sending function, the receiving module is used to implement the receiving function, and the transceiver module can implement the sending function and/or the receiving function.

The communication apparatus may be a terminal device (such as the terminal device in the above method embodiment), or an apparatus in the terminal device, or an apparatus that can be used in combination with the terminal device. Alternatively, the communication apparatus may be a network device, or an apparatus in the network device, or an apparatus that can be used in combination with the network device.

Another communication apparatus is provided in the embodiment of the present disclosure. The communication apparatus may be a network device, or a terminal device (such as the terminal device in the above method embodiments), or a chip, a chip system, or a processor that supports the network device to implement the above methods, or a chip, a chip system, or a processor that supports the terminal device to implement the above methods. The apparatus may be used to implement the methods described in the above method embodiments, and the details may refer to the description in the above method embodiments.

The communication apparatus may include one or more processors. The processor may be a general-purpose processor or a special-purpose processor, or the like. For example, the processor may be a baseband processor or a central processor. The baseband processor can be used to process communication protocols and communication data. The central processor can be used to control the communication apparatus (such as a network side device, baseband chip, terminal device, terminal device chip, DU or CU, etc.), and execute the computer programs, and process data of the computer programs.

Optionally, the communication apparatus may also include one or more memories, on which a computer program may be stored. The processor executes the computer program, so that the communication apparatus performs the steps described in the above method embodiments. Optionally, the memory may also store data. The communication apparatus and the memory can be provided separately or integrated together.

Optionally, the communication apparatus may also include a transceiver and an antenna. The transceiver may be called a transceiver unit, a transceiver, a transceiver circuit, etc., and is used to implement transceiver functions. The transceiver may include a receiver and a transmitter. The receiver may be called a receiver or a receiving circuit, etc., which is used to implement the receiving function. The transmitter may be called a transmitter, a transmitting circuit, etc., which is used to implement the transmitting function.

Optionally, the communication apparatus may also include one or more interface circuits. The interface circuit is used to receive code instructions and transmit them to the processor. The processor executes the code instructions to cause the communication apparatus to perform the methods described in the above method embodiments.

The communication apparatus is a network side device, the processor is used to execute the method shown in FIGS. 1 to 5.

The communication apparatus is a terminal device (such as the terminal device in the above method embodiment), the processor is used to execute the method shown in any one of FIGS. 6 to 10.

In one implementation, the processor may include a transceiver for implementing receiving and transmitting functions. For example, the transceiver may be a transceiver circuit, an interface, or an interface circuit. The transceiver circuit, interface or interface circuit used to implement the receiving and transmitting function can be separate or integrated together. The above transceiver circuit, interface or interface circuit can be used for reading and writing codes/data, or the above transceiver circuit, interface or interface circuit can be used for signal transmission or transfer.

In one implementation, the processor may store a computer program, and the computer program runs on the processor, causing the communication apparatus to perform the method described in the above method embodiment. The computer program may be solidified in the processor, in which case the processor may be implemented by hardware.

In one implementation, the communication apparatus may include a circuit, and the circuit may implement the functions of transmitting or receiving or communicating in the above method embodiments. The processors and transceivers described in this disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), etc.

The communication apparatus described in the above embodiments may be a network device or a terminal device (such as the terminal device in the aforementioned method embodiment), but the scope of the communication apparatus described in the present disclosure is not limited thereto, and the structure of the communication apparatus may not be limited. The communication apparatus may be a stand-alone device or may be part of a large device. For example, the communication apparatus may be:
(1) an independent integrated circuit IC, or chip, or chip system or subsystem;
(2) a collection of one or more ICs. Optionally, the IC collection may also include storage components for storing data and computer programs;
(3) ASIC, such as Modem;
(4) a module that can be embedded in other devices;
(5) a receiver, terminal device, intelligent terminal device, cellular phone, wireless device, handheld machine, mobile unit, vehicle-mounted device, network device, cloud device, artificial intelligence device, etc.;
(6) Others, etc.

For the case where the communication apparatus may be a chip or a chip system, the chip includes a processor and an interface. The number of processors may be one or more, and the number of interfaces may be plural.

Optionally, the chip also includes a memory, which is used to store necessary computer programs and data.

Those skilled in the art can also understand that the various illustrative logical blocks and steps listed in the embodiments of the present disclosure can be implemented by electronic hardware, computer software, or a combination thereof. Whether such function is implemented in hardware or software depends on the specific application and overall system design requirements. Those skilled in the art can use various methods to implement the described functions for each specific application, but such implementation should not be understood as going beyond the protection scope of embodiments of the present disclosure.

The present disclosure also provides a readable storage medium on which instructions are stored. When the instructions are executed by a computer, the functions of any of the above method embodiments are implemented.

The present disclosure also provides a computer program product, which, when executed by a computer, implements the functions of any of the above method embodiments.

In the above embodiments, it may be implemented in whole or in part by software, hardware, firmware, or any combination thereof. When implemented using software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a special-purpose computer, a computer network, or other programmable apparatus. The computer program may be stored in the computer-readable storage medium, or transferred from one computer-readable storage medium to another computer-readable storage medium. For example, the computer program may be transferred from a website, computer, server, or data center to another website, computer, server or data center via wired (such as coaxial cable, optical fiber, digital subscriber line (DSL)) or wireless (such as infrared, wireless, microwave, etc.) manners. The computer-readable storage medium may be any available medium that can be accessed by a computer or a data storage device such as a server, data center, etc. that contains one or more available media integrated. The available media may be magnetic media (e.g., floppy disks, hard disks, magnetic tapes), optical media (e.g., high-density digital video disc (DVD)), or semiconductor media (e.g., solid state disks, SSD)) etc.

Those of ordinary skill in the art can understand that the first, second, and other numerical numbers involved in this disclosure are only for convenience of description and are not used to limit the scope of the embodiments of the disclosure, nor to indicate the order.

At least one in the present disclosure can also be described as one or plural, and the plural can be two, three, four or more, and the present disclosure does not limit this. In the embodiment of the present disclosure, for a technical feature, the technical features among the type of technical features are distinguished by “first”, “second”, “third”, “A”, “B”, “C” and “D” etc. The technical features described with “first”, “second”, “third”, “A”, “B”, “C” and “D” are in no particular sequential order or size order.

Other embodiments of the present disclosure will easily occur to those skilled in the art after considering the specification and practicing the disclosure disclosed herein. The present disclosure is intended to cover any variation, use or adaptation of the present disclosure, which follows the general principles of the present disclosure and includes common sense or common technical means in the technical field not disclosed in this disclosure. The specification and embodiments are to be regarded as example only, with the true scope and spirit of the disclosure being indicated by the attached claims.

It should be understood that the present disclosure is not limited to the precise structure described above and shown in the drawings, and various modifications and changes can be made without departing from its scope. The scope of the present disclosure is limited only by the appended claims.

1. A beam management method, performed by a network side device, and the method comprising:
sending a measurement reference signal to a terminal device by using a beam corresponding to frequency band information, based on the frequency band information of the measurement reference signal.

2. The method according to claim 1, wherein sending a measurement reference signal to a terminal device by using a beam corresponding to frequency band information, based on the frequency band information of the measurement reference signal comprises at least one of the following:
in response to determining that the frequency band information of the measurement reference signal is low frequency band information, sending the measurement reference signal to the terminal device by using a wide beam preferentially;
in response to determining that the frequency band information of the measurement reference signal is high frequency band information, sending the measurement reference signal to the terminal device by using a narrow beam preferentially.

3. The method according to claim 1, further comprising:
sending a first signaling to the terminal device, wherein the first signaling comprises configuration information of the measurement reference signal.

4. The method according to claim 3, wherein the configuration information comprises at least one of the following:
configuration information of a frequency band occupied by the measurement reference signal;
configuration information of a resource block or subcarrier occupied by the measurement reference signal;
configuration information of an antenna port occupied by the measurement reference signal;
configuration information of a time-frequency resource position occupied by the measurement reference signal;
configuration information of a generation parameter of a measurement reference signal sequence.

5. The method according to claim 1, further comprising:
sending a second signaling to the terminal device, wherein the second signaling comprises reporting configuration information of the measurement reference signal.

6. The method according to claim 5, wherein the reporting configuration information comprises at least one of the following:
measurement information of the beam;
reporting condition information of beam measurement;
reporting period information of the beam measurement.

7. The method according to claim 5, further comprising:
receiving beam quality indication information reported by the terminal device for the measurement reference signal.

8. The method according to claim 7, wherein the beam quality indication information comprises at least one of the following:
indication information of the measurement reference signal corresponding to the beam;
measurement information of beam quality.

9. The method according to claim 8, wherein indication information of the measurement reference signal corresponding to the beam comprises at least one of the following:
indication information of a frequency band occupied by the measurement reference signal;
indication information of a resource block or subcarrier occupied by the measurement reference signal;
indication information of an antenna port occupied by the measurement reference signal;
indication information of time-frequency resource occupied by the measurement reference signal.

10. The method according to claim 8, wherein the measurement information of beam quality comprises at least one of reference signal received power (RSRP), reference signal received quality (RSRQ), and signal to interference and noise ratio (SINR).

11. The method according to claim 1, further comprising:
sending a third signaling to the terminal device, wherein the third signaling comprises beam indication information, and the beam indication information is used to indicate a used beam of a data channel and a demodulation reference signal.

12. The method according to claim 11, wherein the beam indication information comprises at least one of the following:
beam indication information for an index of the used beam;
beam indication information for the measurement reference signal associated with the used beam.

13. A beam management method, performed by a terminal device, and the method comprising:
receiving a measurement reference signal sent by a network side device using a beam corresponding to frequency band information of the measurement reference signal.

14. The method according to claim 13, wherein receiving a measurement reference signal sent by a network side device using a beam corresponding to frequency band information of the measurement reference signal comprises at least one of the following:
in response to determining that the frequency band information of the measurement reference signal is low frequency band information, receiving the measurement reference signal sent by the network side device using a wide beam preferentially;
in response to determining that the frequency band information of the measurement reference signal is high frequency band information, receiving the measurement reference signal sent by the network side device using a narrow beam preferentially.

15. The method according to claim 13, further comprising:
receiving a first signaling sent by the network side device, wherein the first signaling comprises configuration information of the measurement reference signal.

16. (canceled)

17. The method according to claim 13, further comprising:
receiving a second signaling sent by the network side device, wherein the second signaling comprises reporting configuration information of the measurement reference signal.

18. (canceled)

19. The method according to claim 13, further comprising:
receiving the measurement reference signal based on configuration information of the measurement reference signal sent by the network side device;
acquiring beam quality indication information by performing beam measurement on the measurement reference signal, based on reporting configuration information of the measurement reference signal sent by the network side device;
sending the beam quality indication information to the network side device.

20.-22. (canceled)

23. The method according to claim 13, further comprising:
receiving a third signaling sent by the network side device, wherein the third signaling comprises beam indication information, and the beam indication information is used to indicate a used beam of a data channel and a demodulation reference signal;
receiving or sending the demodulation reference signal by using the used beam, based on the beam indication information.

24.-26. (canceled)

27. A network side device, comprising a processor and a memory, wherein the memory stores a computer program, and the processor executes the computer program stored in the memory, so that the device performs the method according to claim 1.

28. A terminal device, comprising a processor and a memory, wherein the memory stores a computer program, and the processor executes the computer program stored in the memory, so that the device performs the method according to claim 13.

29.-32. (canceled)
